(19) United States
(12) Patent Application Publication
(10) Pub. No.: US 2006/0082551 A1
(43) Pub. Date: Apr. 20, 2006

(54) Computer mouse structure

(76) Inventors: Vam Chang, Taipei (TW); Yi-Hsin Hsieh, Taipei (TW)

Correspondence Address: HARNESS, DICKEY & PIERCE, P.L.C., P.O. BOX 8910, RESTON, VA, 20195, US

(21) Appl. No.: 10/965,878

(22) Filed: Oct. 18, 2004

(51) Int. Cl. G09G 5/08

(52) U.S. Cl. 345/163

(57) ABSTRACT

A computer mouse structure for preventing foreign materials from accumulating on an X-axle and a Y-axle in the computer mouse includes two scraper seats located on an inner side of a lower shell of the mouse on one side of the X-axle and the Y-axle opposite to a track ball which is in contact with the X-axle and the Y-axle. Each of the scraper seats has a scraper which is spaced from the axle at a selected gap to remove the foreign materials attached to the axle when the foreign materials reach the scraper during rotation of the axle.

### FIELD OF THE INVENTION

The present invention relates to a computer mouse structure and particularly to a computer mouse capable of preventing foreign materials from gathering on the axles.

### BACKGROUND OF THE INVENTION

Conventional computer mice generally can be categorized into mechanical types, semi-optical types and optical types according to the method of obtaining displacement.

The optical type one uses transistors to replace the track ball to achieve more precisely movement. The mechanical type mice and the semi-optical type mice use a track ball, which may be rotated to generate displacements in the X and Y-axes.

The mechanical mouse and semi-optical mouse are the most commonly used at present. They generally have three wheels, arranged in a Y-shape, that include a first wheel on an X-axle, a second wheel on a Y-axle for controlling the cursor on the computer picture and a roller to move the track ball. When the mouse is moved, the track ball rotates to drive the first wheel on the X-axle and the second wheel on the Y-axle to rotate so that the cursor on the picture moves in the X and Y-axes. The roller aims to keep the track ball in close contact with the X-axle and the Y-axle.

The mechanical mouse and the semi-optical mouse differ in the design of the wheels. The mechanical mouse uses encoding wheels, which rotate and generate a corresponding displacement signal through a contact brush. The semi-optical mouse uses an optical grid wheel flanked by photoelectric coupled electronic elements on two sides. The signals generated by photoelectric coupled electronic elements are divided by the rotating optical grid wheel to generate square wave signals. Based on the number and the phases of the square wave signals, the displacement amount and direction of the mouse may be derived.

Either the mechanical mouse or the semi-optical mouse requires a rotating track ball to drive the axles to generate a displacement signal. The track ball usually rolls on a desktop or a mouse pad and tends to gather foreign materials. When the foreign materials are accumulated for a period of time, the track ball could be hindered and not rotate as desired. Then the track ball or the axles have to be removed for clearing. As the axles are located in the mouse, clearing is difficult.

### SUMMARY OF THE INVENTION

In view of the aforesaid problems, the primary object of the present invention is to provide an improved computer mouse structure that may be used conveniently and does not gather foreign materials that hinder rotation of the track ball and result in operation difficulty.

Another object of the invention is to provide an improved computer mouse structure that doesn't need to be disassembled for clearing the axles.

Yet another object of the invention is to provide an improved computer mouse structure that prevents foreign materials from accumulating on the axles that are in contact with the track ball.

In order to achieve the foregoing object, the mouse structure according to the invention provides an improvement on the X-axle and the Y-axle to prevent foreign materials from accumulating thereon. Two scraper seats are provided respectively on an inner side of a lower shell of the mouse on one side of the X-axle and Y-axle opposite to the track ball. Each scrapper seat has a scrapper, which is spaced from the axle at a gap to remove the foreign materials attached to the axle during rotation thereof.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of an embodiment of the invention adopted on a semi-optical mouse;

FIG. 1B is a cross section according to FIG. 1A;

FIG. 2A is a schematic view of another embodiment of the invention adopted on a semi-optical mouse; and

FIG. 2B is a cross section according to FIG. 2A.

### DESCRIPTION OF THE PREFERRED EMBODIMENTS

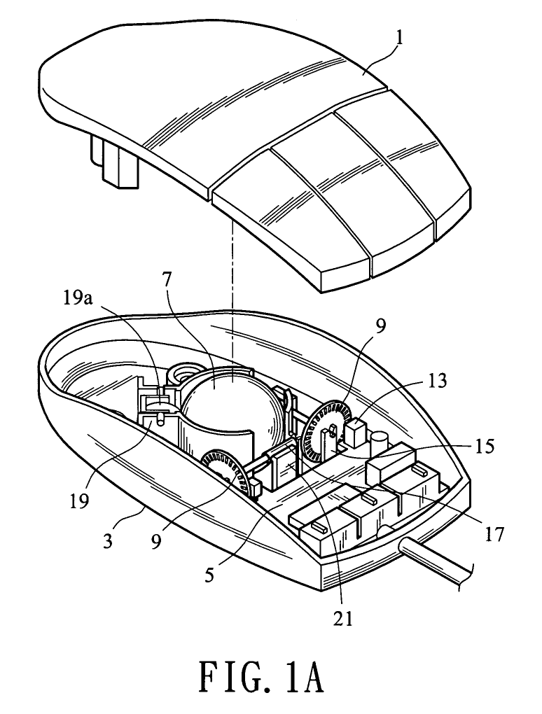

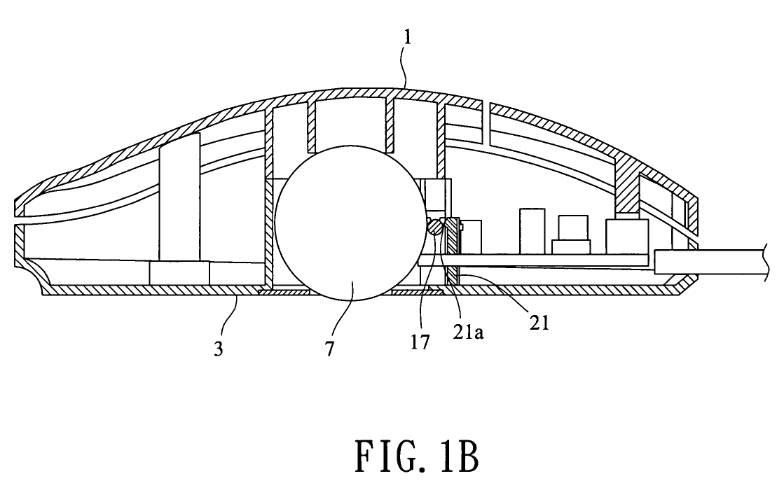

Refer to FIGS. 1A and 1B for an embodiment of the invention that is a semi-optical mouse to serve as an example.

The mouse includes an upper shell 1, a lower shell 3, a circuit board 5, a track ball 7, an X-axis optical grid wheel 9 and a Y-axis optical grid wheel 9.

The circuit board 5 has a pair of photoelectric coupled elements that consist of a LED (not shown in the drawings) and a twin-chip optical transistor 13 corresponding to the X-axis optical grid wheel 9 and the Y-axis optical grid wheel 9 to interpret the mouse location and convert to electronic signals for transferring to a computer. The two optical grid wheels 9 are located respectively in the photoelectric coupled elements and mounted onto an axle rack 15 of the lower shell 3. The optical grid wheels 9 are turning and have respectively an axle 17 in contact with the track ball 7, which is covered by rubber.

There is a roller section 19 on a biased end of the lower shell 3 corresponding to the axles 17 of the optical grid wheels 9.

The roller section 19 has a roller 19a, which is turning and pulled by a spring to exert pressure on the track ball 7 so that the track ball 7 is in contact with the axles 17 constantly.

When the mouse is moved, the track ball 7 rolls, and the optical grid wheels 9 also are driven to rotate. The signals generated by photoelectric coupled elements on two sides of the optical grid wheel 9 are divided by the rotating optical grid to form different number of square wave signals and phases that are used to determine the moving direction and displacement of the mouse.

On the axle racks 15 abutting the axles 17 of the X-axis and Y-axis optical grid wheels 9, there are scraper seats 21 corresponding to the axles 17. Each of the scraper seats 21 has a scraper 21a spaced from the axle 17 at a selected gap. When foreign materials such as dust, accumulate on the axle 17 for a selected thickness, they reach the scraper 21a and are removed during rotation of the axle 17. Thus the foreign materials cannot be accumulated on the axle 17 excessively.

Refer to FIG. 1B for the scraper 21a and the axle 17 at another angle. In practice, the scraper 21a may be located on any angle relative to the axle 17.

Moreover, an additional scraper seat may be included in the mouse on an outer side of the roller. Foreign materials attached to the roller may also be removed when they reach the scraper while the roller rotates.

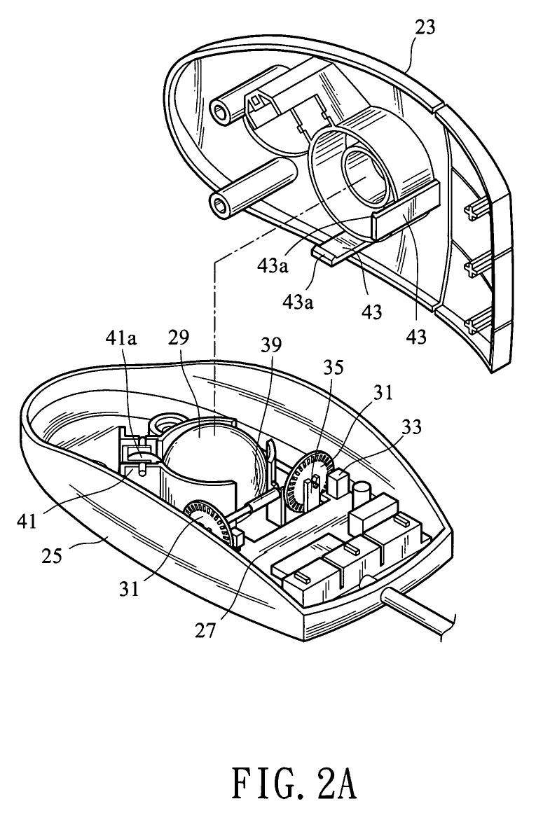

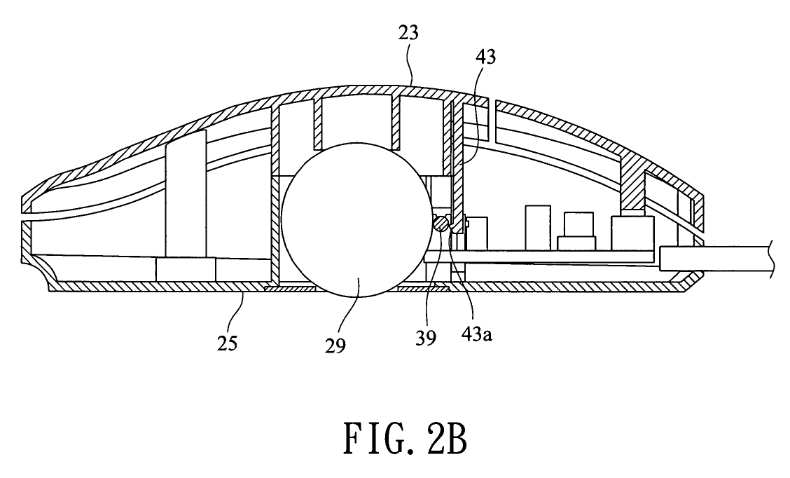

Refer to FIGS. 2A and 2B for another embodiment of the invention that is a semi-optical mouse, serving as an example.

The mouse includes an upper shell 23, a lower shell 25, a circuit board 27, a track ball 29, an X-axis optical grid wheel 31 and a Y-axis optical grid wheel 31.

The circuit board 27 has a pair of photoelectric coupled elements that consist of a LED (not shown in the drawings) and a twin-chip optical transistor 33 corresponding to the X-axis optical grid wheel 31 and the Y-axis optical grid wheel 31, to interpret the mouse location and convert to electronic signals for transferring to a computer. The two optical grid wheels 31 are mounted onto an axle rack 35 of the lower shell 25. The optical grid wheels 31 are turning and have an axle 39 in contact with the track ball 29 which is covered by rubber.

There is a roller section 41 on a biased end of the lower shell 25 corresponding to the axles 39 of the optical grid wheels 31.

The roller section 41 has a roller 41a, which is turning and pulled by a spring to exert pressure on the track ball 29 so that the track ball 29 is in contact with the axles 39 constantly.

When the mouse is moved, the track ball 29 rolls, and the optical grid wheels 31 also are driven to rotate. The signals generated by the photoelectric coupled elements on two sides of the optical grid wheels 31 are divided by the rotating optical grid to form different number of square wave signals and phases that are used to determine the moving direction and displacement of the mouse.

Inside the upper shell 23 corresponding to the axles 39, there are two corresponding scraper seats 43. Each of the scraper seats 43 has a scraper 43a spaced from the axle 39 at a selected gap. When foreign materials accumulate on the axle 39 for a selected thickness, they reach the scraper 43a and are removed during rotation of the axle 39. Thus the foreign materials cannot be accumulated on the axle 39 excessively.

Refer to FIG. 2B for the scraper 43a and the axle 39 at another angle. In practice the scraper 43a may be located on any angle relative to the axle 39.

Moreover, an additional scraper seat may be included in the mouse on an outer side of the roller. Foreign materials attached to the roller may also be removed when they reach the scraper while the roller rotates.

Although the embodiments set forth above are used on a semi-optical mouse, the invention may be adopted on any mouse that has a track ball, such as a mechanical mouse.

In summary, the invention provides a scraper seat abutting an X-wheel and a Y-wheel to remove foreign materials, gathered on the axles during rotation to prevent the foreign materials from accumulating on the axles. Thus the track ball can rotate as desired without impediment caused by accumulating foreign materials. This can free users from the trouble of disassembling the mouse to clean the axles. Users also can use the mouse smoothly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A computer mouse structure for preventing foreign materials from accumulating on a X-axle and a Y-axle in the computer mouse, comprising two scraper seats located on an inner side of a lower shell of the mouse on one side of the X-axle and the Y-axle opposite to a track ball which is in contact with the X-axle and the Y-axle, each of the scraper seats having a scraper which is spaced from the axle at a selected gap to remove the foreign materials attached to the axle when the foreign materials reach the scraper during rotation of the axle.

2. The computer mouse structure of claim 1 further having another scraper seat located on an outer side of a roller in the mouse that has a scraper to remove foreign materials attached to the roller when the foreign materials reach the scraper during rotation of the roller.

3. A computer mouse structure for preventing foreign materials from accumulating on a X-axle and a Y-axle in the computer mouse, comprising two scraper seats located on an inner side of a upper shell of the mouse corresponding to the X-axle and the Y-axle located in a lower shell of the mouse, each of the scraper seats having a scraper which is spaced from the axle at a selected gap to remove the foreign materials attached to the axle when the foreign materials reach the scraper during rotation of the axle.

4. The computer mouse structure of claim 3 further having another scraper seat located on an outer side of a roller in the mouse that has a scraper to remove foreign materials attached to the roller when the foreign materials reach the scraper during rotation of the roller.
